(19) United States
(12) Patent Application Publication
(10) Pub. No.: US 2026/0230000 A1
(43) Pub. Date: Aug. 6, 2026

(54) POWER CONVERSION DEVICE

(71) Applicant: HITACHI ASTEMO, LTD., Chiyoda-ku, Tokyo (JP)

(72) Inventors: Tomohiro TAGUCHI, Hitachinaka-shi, Ibaraki (JP); Shoho ISHIKAWA, Hitachinaka-shi, Ibaraki (JP)

(73) Assignee: ASTEMO, LTD., Chiyoda-ku, Tokyo (JP)

(21) Appl. No.: 19/157,422

(22) PCT Filed: Mar. 22, 2023
(86) PCT No.: PCT/JP2023/011311

§ 371 Date: Aug. 18, 2025

(51) Int. Cl. H02M 7/00; H02K 5/22; H02K 11/33

(52) U.S. Cl. CPC H02M 7/003; H02K 5/225; H02K 11/33

(57) ABSTRACT

A power conversion device that is fixedly connected to a motor housing that houses a motor includes a case having a plurality of side walls and having an opening on a motor side, a cover that covers a top surface of the case, and a plurality of internal components housed in the case. The plurality of internal components includes a capacitor. The case includes a connection portion connected to the motor housing and a plurality of fixing portions that fixes the capacitor to an inside of the case. In the case, a first space is provided between the capacitor and the cover, and a second space is provided between the capacitor and the motor. The plurality of internal components is disposed to connect a pair of opposing side walls among the plurality of side walls.

### TECHNICAL FIELD

The present invention relates to a power conversion device.

### BACKGROUND ART

Regarding a case shape of a power conversion device for an electric vehicle or a hybrid vehicle, for example, PTL 1 discloses a power conversion device having a structure including a floor surface for holding components and securing strength.

### CITATION LIST

### Patent Literature

PTL 1: JP 2013-115903 A

### SUMMARY OF INVENTION

### Technical Problem

In PTL 1, since a large projection area is required on a floor surface, the size of a casting machine is increased, which causes an increase in cost. Further, since the case has the floor surface, the space inside or at the bottom of the case is partitioned, and the layout of the components is restricted. This causes an increase in the dimension of an inverter in a height direction. In addition, as to the strength of the components, it has been difficult to secure mechanical strength because the components have been conventionally assembled individually one by one.

### Solution to Problem

A power conversion device that is fixedly connected to a motor housing that houses a motor includes a case having a plurality of side walls and having an opening on a motor side, a cover that covers a top surface of the case, and a plurality of internal components housed in the case. The plurality of internal components includes a capacitor. The case includes a connection portion connected to the motor housing and a plurality of fixing portions that fixes the capacitor to an inside of the case. In the case, a first space is provided between the capacitor and the cover, and a second space is provided between the capacitor and the motor. The plurality of internal components is disposed to connect a pair of opposing side walls among the plurality of side walls.

### ADVANTAGEOUS EFFECTS OF INVENTION

According to the present invention, a power conversion device that achieves cost reduction, downsizing, suppression of strength reduction, and improvement in an assembly property can be provided.

### BRIEF DESCRIPTION OF DRAWINGS

FIG. 1 is an overall perspective view of a power conversion device.

FIG. 2 is an exploded view of FIG. 1 according to one embodiment of the present invention.

FIG. 3 is a cross-sectional view of the device as viewed from an arrow A of FIG. 2 according to one embodiment of the present invention.

FIG. 4 is a top view of an inverter case according to one embodiment of the present invention.

FIG. 5 is a plan view of a capacitor as viewed from an upper direction and a front view thereof as viewed from an arrow B according to one embodiment of the present invention.

Hereinafter, an embodiment of the present invention will be described with reference to the drawings. The following description and drawings are examples for describing the present invention, and are omitted and simplified as appropriate for the sake of clarity of the description. The present invention can be carried out in various other modes. As for each component, unless otherwise specified, single component or a plurality of components may be provided.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the positions, sizes, shapes, ranges, and the like disclosed in the drawings.

### First Embodiment and Overall Configuration of Present Invention

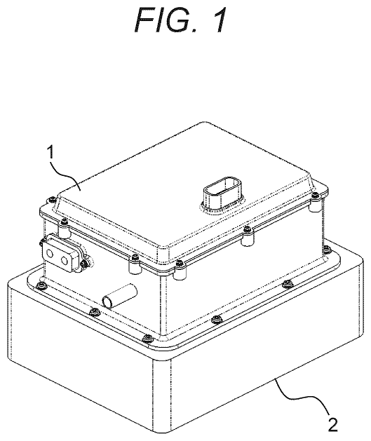

### FIG. 1

The bottom surface side of an inverter 1 is attached to and fixedly connected to a motor housing 2 by fastening means such as screws. The motor housing 2 houses a motor, not illustrated, and has a function as a pedestal of the inverter 1 since the inverter 1 is fixedly connected thereto.

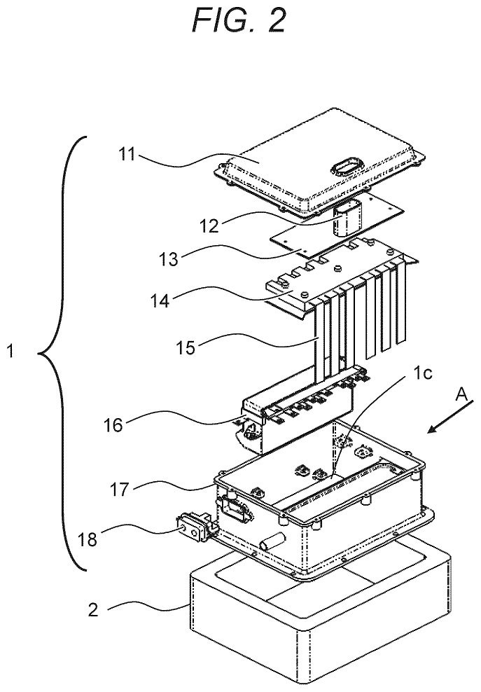

### FIG. 2

The inverter 1 includes a top cover 11 and an inverter Case 17. The inverter case 17 is made of metal, and has a plurality of side walls and an opening 1c. The opening is on a motor side (motor housing 2 side), not illustrated. The inverter case 17 has a plurality of inverter components such as a capacitor 16 therein. The top cover 11 is attached so as to cover the top surface (upper surface in FIG. 2) of the inverter case 17, thereby protecting the internal components in the inverter case 17. The inverter case 17 houses a low voltage (LV) connector 12, a ground substrate 13, a power module 14, a bus bar 15, and a capacitor 16 as the internal components. Further, the inverter case 17 has a direct-current (DC) connector 18 that is a connection interface connected to external components on the outer sides of the side walls.

The LV connector 12 is a connection interface for connecting the inverter 1 to external components on the top cover 11 side, and penetrates the top cover 11. Note that the LV connector 12 penetrates any position of the top cover 11, and may penetrate another position on the top cover 11.

The ground substrate 13 controls the inverter 1. The power module 14 converts power to be input to the inverter 1 and monitors a current. The power module 14 is integrated with a path, not illustrated, through which cooling water flows in the inverter 1. The bus bar 15 connects the power module 14 and the motor, not illustrated, mounted in the motor housing 2. The capacitor 16 rectifies power input from the outside of the inverter 1 via the DC connector 18 and causes the rectified power to flow into the power module 14. Further, the capacitor 16 reduces emission noises. The DC connector 18 is a connection interface that connects a power supply outside the inverter 1 and the inverter 1.

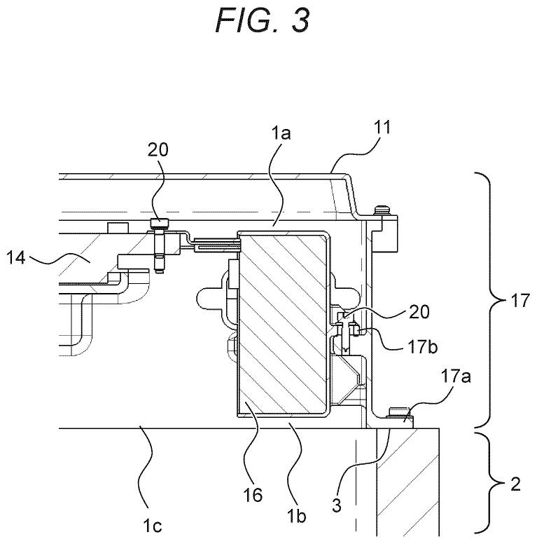

### FIG. 3

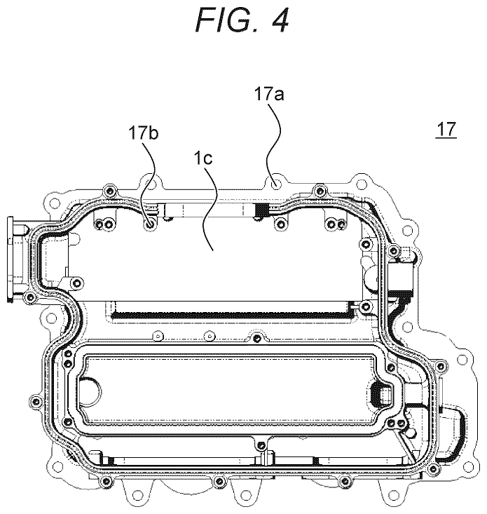

The inverter case 17 includes a plurality of fixing portions 17b for fixing the capacitor 16 to the inside of the inverter case 17. The capacitor 16, which has fixing portions corresponding to the plurality of fixing portions 17b, is fixedly connected to the power module 14 and the inverter case 17 by aligning the fixing portions and inserting fixing members 20 such as screws thereinto. Further, the inverter case 17 has a case fixing portion 17a outside, and is connected to the motor housing 2 by inserting a fixing member or the like into the case fixing portion 17a to form a connection portion 3. An opening 1c is formed between a space at the position of the capacitor 16 in an internal space of the inverter case 17 and an internal space of the motor housing 2. The opening 1c will be described later with reference to FIG. 4.

The inverter case 17 has a first space la between the capacitor 16 and the top cover 11, and a second space 1b between the capacitor 16 and the motor housing 2 (or the motor, not illustrated). Since the first space la and the second space 1b are formed in the inverter case 17, wiring connected to the capacitor 16 is easily routed. Further, connection between the internal components in the inverter case 17 and the motor, not illustrated, housed in the motor housing 2 is facilitated. As will be described later with reference to FIG. 4, the capacitor 16 serves as a beam of the inverter case 17, and contributes to ensuring the strength of the inverter case 17.

### FIG. 4

The inverter case 17 has the opening 1c. The inverter case 17 further includes the plurality of fixing portions 17a and the plurality of fixing portions 17b. The above-described capacitor 16 is fixed in the inverter case 17 by the capacitor fixing portions 17b.

Conventionally, since the inverter case 17 has a floor surface, the components to be mounted inside the inverter case 17 can be mounted only from one direction. In addition, since the bus bar to be routed in the inverter case 17 also requires a step of making a hole on the floor surface for connection with the motor side, the manufacturing steps increase.

However, since the inverter case 17 has the opening lc on the floor surface as in the present invention, the internal components can be mounted from either of both surfaces of the inverter case 17. Therefore, the flexibility of the assembly order of the internal components is heightened, and the space in the inverter case 17 can be effectively used for disposing the components, thereby heightening the flexibility of disposing the internal components. In addition, the presence of the opening 1c heightens the flexibility of disposing the bus bar to be routed in the inverter case 17, and thus spatial efficiency is improved.

Since the opening 1c is disposed in the inverter case 17, a projection area is reduced, and a casting cost and the weight can be reduced. Further, since the capacitor 16 is installed to be aligned with a formation position of the opening 1c, the capacitor 16 serves as a structural member of the inverter case 17. Specifically, the capacitor 16 has a function as the beam of the inverter case 17 by being disposed to connect a pair of opposing side walls among the side walls of the inverter case 17. Further, not only the capacitor 16 but also the above-described power module 14 is installed at a position in the inverter case 17, the position being different from the installation position of the capacitor 16. As a result, the power module 14 has a role of the beam as a structural member of the inverter case 17. In this way, the strength of the inverter case 17 can be secured by each internal component.

The power module 14 and the capacitor 16 are mounted into the inverter case 17 to serve as the beam in the inverter case 17. The value of the natural frequency varies for respective members. Therefore, even in a case where one member of the power module 14 and the capacitor 16 resonates when resonance occurs, the other member serves as the beam. As a result, vibration of the side walls of the inverter case 17 can be attenuated, and deformation of the inverter case 17 can be suppressed. Thus, strength at the time of resonance can be secured.

Regarding the plurality of fixing portions 17b included in the inverter case 17, since heavy components, such as the capacitor 16 and the power module 14, need to be fixed to the inside of the inverter case 17, the strength of the fixing portions 17b themselves needs to be enhanced. Therefore, in order to enhance the strength of the fixing portions 17b more than the strength of the side walls, the rigidity of the side walls of the inverter case 17 is made lower than the rigidity of the fixing portions 17b. Thus, the force applied to the wall surfaces of the inverter case 17 can be transferred to the internal component side through the fixing portions 17b. Further, transmission of vibration and impact to the capacitor 16 can be prevented by improving the rigidity of the fixing portions 17b. This can not only secure the strength of the wall surfaces themselves but also contribute to the improvement in earthquake resistance.

Note that with a method for enhancing the rigidity of the fixing portions 17b, high mechanical strength may be ensured, for example, by forming the fixing portions 17b in a thick shape or a rib shape or the like formed on an outer peripheral side (side wall outer side) of the fixing portions 17b.

Further, such a configuration of the fixing portions 17b also contributes to solving the problem that the strength of the inverter case 17 is reduced due to the presence of the opening 1c. Specifically, the wall surfaces of the inverter case 17 having a lower strength than the fixing portions 17b can be made thinner. Since the inverter case 17 is elastically deformed by the presence of the opening 1c, for example, an absorption effect can be achieved against vibration and impact transmitted from the motor, and impact generated in the fixing portions 17b can also be dampened.

Further, also in terms H routing the bus bar and the wiring connected to the motor side, the provision of the opening lc can reduce the design burden because the machining accuracy regarding the tolerance of the hole on the inverter case 17 side does not need to be considered, and thus only the positional tolerance of the bus bar is considered. That is, since the inverter case 17 does not have the floor surface, the connectivity between the internal components in the inverter case 17 and the components disposed on the motor side is improved. This facilitates the efficiency of the space inside the inverter case 17.

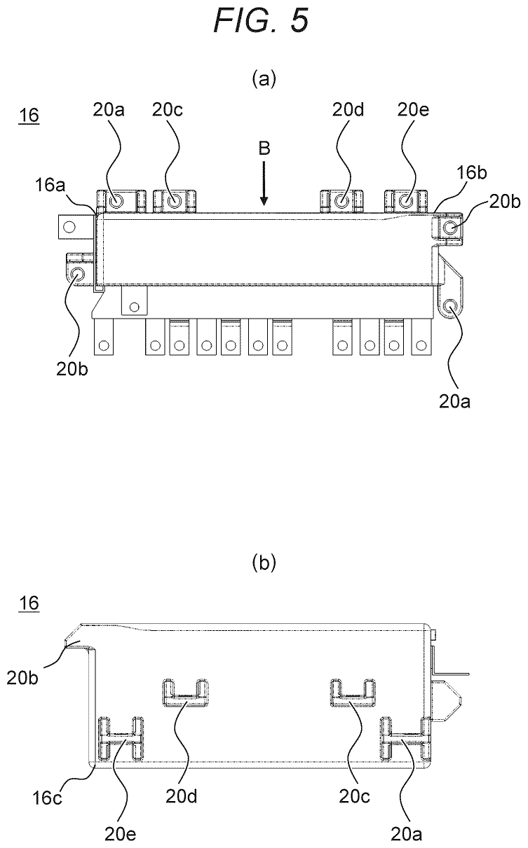

### FIG. 5

FIG. 5 (a) is a plan view of the capacitor 16 as viewed from the top surface, and an explanatory view of a plurality of fixing portions 20a to 20e disposed in the capacitor 16. FIG. 5(b) is a front view of the capacitor 16 as viewed from a direction B of FIG. 5(a).

The capacitor 16 has the fixing portions 20a to 20e for fixing the capacitor to the inverter case 17. The connection between the capacitor 16 and the inverter case 17 does not necessarily need to use screws or the like. For example, bolts or the like may be set to stand on the inverter case 17 side and the bolts or the like may be fixed with nuts. Alternatively, a snap-fit structure may be provided on the inverter case 17 or the capacitor 16, and the capacitor 16 and the inverter case 17 are fixed by fitting the snap-fit structure.

A countermeasure against lateral swing of the inverter case 17 will be described. The fixing portions 20a to 20e illustrated in FIG. 5(a) and 5 (b) are disposed so that the distance between the fixing portions close to each other is as short as possible.

In the capacitor 16, the fixing portions 20a are fixed to each other, and the fixing portions 20b are fixed to each other. In this way, by fixing the fixing portions 20a to each other, a truss shape is formed by the pair of fixing portions 20a and a corner portion 16b of the capacitor 16. Therefore, the strength of the capacitor 16 and the inverter case 17 is secured, and the entire vibration can be suppressed. In a similar way, by fixing the fixing portions 20b to each other, a truss shape is formed by the pair of fixing portions 20b and a corner portion 16a of the capacitor 16. Therefore, the strength of the capacitor 16 and the inverter case 17 is secured, and the entire vibration can be suppressed.

Further, by fixing the fixing portion 20c illustrated in FIG. 5(a), a small truss shape is formed by the fixing portion 20c, the fixing portion 20d, which is formed in a short-length direction of the capacitor 16 and is close to the fixing portion 20c, and the corner portion 16a. Therefore, vibration of the corner portion 16a of the capacitor 6 can be suppressed. In a similar way, by fixing the fixing portion 20d, a small truss shape is formed by the fixing portion 20d, the fixing portion 20a, which is formed in a short-length direction of the capacitor 16 and is close to the fixing portion 20d, and the corner portion 16b. Therefore, vibration of the corner portion 16b of the capacitor 6 can be suppressed. In such a manner, the strength of the capacitor 16 in the inverter case 17 can be secured, the influence range where the internal components function as the beam in the inverter case 17 can be expanded, and the strength can be further secured.

In a case where the capacitor 16 is fixed to the inverter case 17 with as few fixing members as possible, priority is given to fixing between the fixing portions 20a and between the fixing portions 20b rather than fixing between the fixing portions 20c and 20d, thereby reliably securing the strength.

Next, a countermeasure against the vertical swing of the inverter case 17 will be described using the plurality of fixing portions 20a to 20e illustrated in FIG. 5(b). The plurality of fixing portions 20a to 20e includes a combination of fixing portions disposed at different positions in a thickness direction of the capacitor 16. Specifically, the combinations include three sets including a set of the fixing portions 20b illustrated in FIG. 5(b) (the other is illustrated in FIG. 5(a)), a set of the fixing portions 20c and 20d, and a set of the fixing portions 20a and 20e. In this way, the capacitor 16 can be uniformly fixed to the inverter case 17 to have strength.

Further, in FIG. 5(b), a truss shape is formed by the fixing portion 20a, the fixing portion 20b, and the corner portion 16c, and two points as distant as possible from each other on both end portions of the capacitor 16 can be connected. As a result, a role of the beam of the capacitor 6 in the inverter case 17 can be obtained, vibration resistance is improved, and an influence range functioning as the beam can be expanded.

In FIG. 5(b), the fixing portion 20a and the fixing portion 20c, and the fixing portion 20d, the fixing portion 20e, and the fixing portion 20b can achieve the fixing that reinforces the central portion of the capacitor 6. Therefore, the strength of the capacitor 16 can be further secured.

Further, as a countermeasure against the natural vibration (countermeasure against resonance) of the inverter case 17, the plurality of fixing portions 20a to 20e includes a combination of the fixing portions 20a to 20e disposed at the same position in the thickness direction of the capacitor 16 as illustrated in FIG. 5(b) in consideration of the fact that a portion that easily swings varies in respective vibration modes. Specifically, in the thickness direction of the capacitor 16, the fixing portions 20b are aligned at the same position, the t fixing portions 20c and the fixing portions 20d are aligned at the same height, and the fixing portions 20a and the fixing portions 20e are aligned at the same height. In this way, an assembly property can be improved.

As described above, the risk of insufficient strength due to the opening 1c of the inverter case 17 can be eliminated by the above-described configuration of the plurality of fixing portions 20a to 20e included in the capacitor 16. Furthermore, the strength equivalent to the strength of the floor surface can be secured by fastening the inverter case 17 to the motor housing 2. As a result, strength and a sealing property can also be secured.

In addition, in a conceivable case where the inverter 1 is fixed too firmly, the inverter case 17 is elastically deformed due to the configuration of the present invention even when vibration or impact is directly transmitted to the fixing portions. Therefore, an effect of dampening the impact can be expected.

According to the embodiment of the present invention described above, the following operational effects are produced.

(1) The power conversion device fixedly connected to the motor housing 2 that houses the motor includes the case 17 having the plurality of side walls and having the opening on the motor side, the cover 11 that covers the top surface of the case 17, and the plurality of internal components housed in the case 17. The plurality of internal components includes the capacitor 16, and the case 17 includes the connection portion 3 connected to the motor housing 2 and the plurality of fixing portions 17b that fixes the capacitor 16 to the inside of the case 17. In the case 17, the first space la is provided between the capacitor 16 and the cover 11, the second space 1b is provided between the capacitor 16 and the motor, and the plurality of internal components is disposed to connect the pair of opposing side walls to each other among the plurality of side walls. Such a configuration makes it possible to reduce the number of reinforcing members such as a bottom plate, dampen the impact on the fixing portions 20a to 20e and the capacitor 16, improve the routing property of wiring, and reduce a cost due to easing of tolerance.

(2) In the inverter case 17, the side walls have rigidity lower than the rigidity of the fixing portions 20a to 20e. Such a configuration makes it possible to reduce the weight of the inverter case 17 and enhance the rigidity of the fixing portions 20a to 20e.

(3) The capacitor 16 is disposed to connect the pair of opposing side walls to each other among the plurality of side walls. With this configuration, the strength of the inverter case 17 can be secured.

(4) The plurality of fixing portions 20a to 20e includes a pair of fixing portions that forms a truss shape with the corner portion of the capacitor 16 as viewed from the cover 11 side. In this way, the strength of the members in the capacitor 16 can be secured and the range of influence of the beam can be expanded.

(5) The plurality of fixing portions 20a to 20e includes a combination of fixing portions disposed at different positions in a thickness direction of the capacitor 16. In this way, the strength of the members in the capacitor 16 can be secured and the range of influence of the beam can be expanded.

(6) The plurality of fixing portions 20a to 20e includes a combination of the fixing portions disposed at an identical position in a thickness direction of the capacitor 16. In this way, the strength of the members in the capacitor 16 can be secured, the range of influence of the beam can be expanded, and manufacturability can be secured.

Note that the present invention is not limited to the above embodiment, and various modifications and other configurations can be combined without departing from the gist of the present invention. In addition, the present invention is not limited to one including the entire configuration described in the above embodiment, and includes one from which a part of the configuration is deleted.

### REFERENCE SIGNS LIST

1 inverter
1a first space
1b second space
1c opening
2 motor housing
3 case connecting portion
11 top cover
12 LV connector
13 ground substrate
14 power module
15 bus bar
16 capacitor
16a to 16c corner portion
17 inverter case
17a case fixing portion
17b capacitor fixing portion
18 DC connector
20 fixing member
20a to 20e fixing portion

1. A power conversion device that is fixedly connected to a motor housing that houses a motor, the power conversion device comprising:
a case having a plurality of side walls and having an opening on a motor side;
a cover that covers a top surface of the case; and
a plurality of internal components housed in the case,
wherein the plurality of internal components includes a capacitor,
wherein the case includes a connection portion connected to the motor housing and a plurality of fixing portions that fixes the capacitor to an inside of the case,
wherein in the case, a first space is provided between the capacitor and the cover, and a second space is provided between the capacitor and the motor, and
wherein the plurality of internal components is disposed to connect a pair of opposing side walls among the plurality of side walls.

2. The power conversion device according to claim 1, wherein the plurality of the side walls has rigidity lower than rigidity of the plurality of fixing portions.

3. The power conversion device according to claim 1, wherein the capacitor is disposed to connect the pair of opposing side walls to each other among the plurality of side walls.

4. The power conversion device according to claim 1, wherein the plurality of fixing portions includes a pair of fixing portions that forms a truss shape with respect to a corner portion of the capacitor as viewed from a cover side.

5. The power conversion device according to claim 1, wherein the plurality of fixing portions includes a combination of the fixing portions disposed at different positions in a thickness direction of the capacitor.

6. The power conversion device according to claim 1, wherein the plurality of fixing portions includes a combination of the fixing portions disposed at an identical position in a thickness direction of the capacitor.
